(19) United States
(12) Patent Application Publication
(10) Pub. No.: US 2020/0242641 A1
(43) Pub. Date: Jul. 30, 2020

(54) METHOD OF DATA FORECAST ANALYSIS AND ELECTRONIC DEVICE USING THE SAME

(71) Applicant: SAMSUNG ELECTRONICS CO., LTD., Suwon-si (KR)

(72) Inventors: Hong Yoon Kim, Suwon-si (KR); Kimin Oh, Suwon-si (KR); Kihoon Cha, Suwon-si (KR)

(73) Assignee: SAMSUNG ELECTRONICS CO., LTD., Suwon-si (KR)

(21) Appl. No.: 16/712,187

(22) Filed: Dec. 12, 2019

(30) Foreign Application Priority Data
Jan. 24, 2019 (KR) 10-2019-0009350

(51) Int. Cl. G06Q 30/02; G06F 16/28

(52) U.S. Cl. CPC G06Q 30/0202; G06F 16/285

(57) ABSTRACT

An electronic device includes a display, a memory and a processor configured to set a plurality of products into a plurality of product groups based on respective specific factor values of the plurality of products; set the plurality of product groups into a plurality of segments based on comparison between the plurality of product groups; identify per-segment information for the plurality of segments; generate forecast data by processing prior time-series data based on the per-segment information; and control the display to display at least part of the forecast data.

### CROSS-REFERENCE TO RELATED APPLICATION(S)

This application is based on and claims priority under 35 U.S.C. § 119 to Korean Patent Application No. 10-2019-0009350, filed on Jan. 24, 2019, in the Korean Intellectual Property Office, the disclosure of which is incorporated by reference herein in its entirety.

### BACKGROUND

### 1. Field

Various embodiments of the disclosure relate to methods of data forecast analysis and electronic devices using the same.

### 2. Description of Related Art

Various issues may come into play in relation to product demand forecasting via market analysis.

For example, time-based demand forecasting requires a precise decision based on seasonality. Here, seasonality may refer to the nature changing over time or changes in consumer demand as season changes. Seasonality may lead to a change in demand as a result of a variation in, e.g., weather, holiday, or vacation. For example, factors such as Black Friday or Chinese New Year during which market sales in the U.S. or China are surging may influence seasonality of products.

Precise product demand forecasting requires sell-out data (e.g., sales record) accumulated for at least several years. Seasonality is typically determined by applying an algorithm based on accumulated sell-out data to extract a predetermined pattern. In the case of products for which there is no past sell-out data accumulated over a sufficient period of time, conventional approach cannot give reliable analysis results of seasonality.

For relatively short-market cycle products (e.g., cell phones or TVs), development of new models and discontinuation of existing models are frequent and sales do not last longer than few years or more. For example, in the case of TVs, new models debut in the market every year with different sales trends than that of prior models.

Therefore, if the seasonality is obtained by relying entirely on past per-product sell-out data accumulated, its applicability may be limited to specific products or periods.

The above information is presented as background information only to assist with an understanding of the disclosure. No determination has been made, and no assertion is made, as to whether any of the above might be applicable as prior art with regard to the disclosure.

### SUMMARY

Provided is a data forecast analysis method and electronic device using the same, which may obtain more precise and reliable analysis results in relation to demand forecasting.

According to an embodiment, there is provided an electronic device including a display, a memory and a processor configured to set a plurality of products into a plurality of product groups based on respective specific factor values of the plurality of products; set the plurality of product groups into a plurality of segments based on comparison between the plurality of product groups; identify per-segment information for the plurality of segments; generate forecast data by processing prior time-series data based on the per-segment information; and control the display to display at least part of the forecast data.

The specific factor values may be used to classify the plurality of products.

The plurality of products may be placed into the plurality of segments based on time.

The specific factors may be set depending on product types.

The processor may be further configured to reset the plurality of product groups and the plurality of segments based on an update on the plurality of products.

The per-segment information may include at least one of a correction factor, a weight, and a seasonal factor set for each of the plurality of segments.

The per-segment information may be set based on the prior time-series data.

The prior time-series data may include data during a segmented period, and the forecast data comprises data during a summated period corresponding to a plurality of segmented periods.

The prior time-series data may include time-series data during a first period before a specific time, and the forecast data may include time-series data during a second period after the specific time, and the second period may be set to be longer than the first period.

The prior time-series data may include at least one of per-product data for the plurality of products, per-product group data for the plurality of product groups, and per-segment data for a plurality of preset segments.

The processor may be further configured to set the plurality of product groups into the plurality of segments based on a designated clustering rule.

The processor may be further configured to, upon setting the plurality of product groups into the plurality of segments, sequentially classify non-dominated sets from the plurality of product groups based on comparison between the plurality of product groups and set the non-dominated sets into the plurality of segments.

According to another embodiment, there is provided a method of data forecast analysis, the method including setting a plurality of products into a plurality of product groups based on respective specific factor values of the plurality of products; setting the plurality of product groups into a plurality of segments based on comparison between the plurality of product groups; identifying per-segment information for the plurality of segments; generating forecast data by processing prior time-series data based on the per-segment information; and displaying at least part of the forecast data on a display.

The specific factor values may be used to classify the plurality of products.

The plurality of products may be placed into the plurality of segments based on time.

The specific factors may be set depending on product types.

The method may further include resetting the plurality of product groups and the plurality of segments based on an update on the plurality of products.

The per-segment information may include at least one of a correction factor, a weight, and a seasonal factor set for each of the plurality of segments.

The per-segment information may be set based on the prior time-series data.

The prior time-series data may include data during a segmented period, and the forecast data may include data during a summated period corresponding to a plurality of segmented periods.

### BRIEF DESCRIPTION OF THE DRAWINGS

The above and other aspects, and features of certain embodiments of the disclosure will become more apparent to those skilled in the art from the following detailed description, taken in conjunction with the accompanying drawings, in which:

FIG. 1 is a block diagram illustrating an electronic device according to an embodiment;

FIGS. 2A and 2B are views illustrating a clustering rule according to an embodiment;

FIGS. 3A and 3B are reference views illustrating the concept of clustering according to an embodiment;

FIG. 4 is a view illustrating an example variation in clustering according to an embodiment;

FIG. 5 is a flowchart illustrating a data forecasting analysis operation according to an embodiment;

FIG. 6 is a flowchart illustrating a data forecasting analysis operation according to an embodiment;

FIGS. 7A and 7B are graphs illustrating results of data forecasting analysis according to an embodiment;

FIGS. 8A, 8B, and 8C are graphs illustrating results of data forecasting analysis according to an embodiment;

FIG. 9 is a table illustrating results of analysis of seasonal data according to an embodiment;

FIG. 10 is a view illustrating an example screen for performing data forecasting analysis according to an embodiment;

FIG. 11 is a table illustrating ordering factors per product type according to an embodiment; and

FIG. 12 is a block diagram illustrating an electronic device in a network environment according to an embodiment.

### DETAILED DESCRIPTION

The hierarchy of product, product group, and segment may be set in the order of product<product group<segment. “Product” may be referred to as goods or commodity, article, or item, and may refer to a single sell-out unit. “Product group” may refer to a set of at least one or more products. “Segment” may refer to a set of at least one or more product groups.

“Specific factor” may refer to a product-related factor, such as image quality, inches, color, or specs. Further, “Specific factor” may refer to information corresponding to each attribute, feature of the product, and/or a factor related to the product specs.

“Ordering factor” may refer to a factor, such as image quality or inches, among product-related factors. “Ordering factor” may refer to information indicating the ordinal feature of the product. A plurality of products may be sorted ordinally (e.g., in order of image quality or inches) based on an ordering factor(s).

“Clustering” may refer to setting or determining a plurality of segments. “Clustering” may refer to an operation for determining the segment where the product belongs. As a result of clustering, data forecasting may be performed per determined segment. The segment where the product belongs may be determined based on the current position of the product on the market.

The segment where the product belongs may be vary over time or as the technology for selling products advances. The segment in which a specific product belongs to may also vary depending on the time of clustering. For example, a certain product may be classified as belonging to a first segment corresponding to the highest-specs at a first time (in the past) and a second segment corresponding to the medium-specs at a second time (at the present time).

As an example, the segment where each product belongs may be determined based on the specs of each product. A plurality of segments may be divided depending on product spec levels. When the plurality of segments are divided into a first segment, a second segment, and a third segment, the first segment, the second segment, and the third segment may correspond to the highest-specs, the medium-specs, and the lowest-specs, respectively. Clustering may be an operation for dividing a plurality of products or a plurality of product groups into a plurality of segments.

As an example, each of a plurality of products (e.g., televisions (TVs)) may have a different ordering factor value (e.g., different image qualities or inches). A plurality of products may be divided into a plurality of product groups based on at least two or more ordering factors (e.g., image qualities and inches) among product spec-related factors. The respective corresponding segments of the plurality of product groups may be assigned based on comparison between the plurality of product groups.

“Time-series data” may be data that is represented as a function of time for a predetermined period. “Time-series data” may represent a variation in data over time. “Time-series data” may be represented as at least any one of per-product data, per-product group data, or per-segment data. “Time-series data” may be in the form of sell-out data or seasonality data. “Time-series data” may be data in the form that may be clustered and processed on a per-segment basis, as well as seasonality data or sell-out data.

The following embodiments are described assuming a scenario where time-series data is sell-out data or seasonality data for ease of description. However, time-series data is not limited thereto, but may adopt other various types of data that are clusterable.

Hereinafter, embodiments of the disclosure are described with reference to the accompanying drawings.

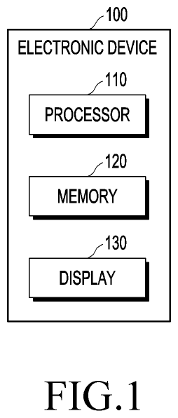

FIG. 1 is a block diagram illustrating an electronic device according to an embodiment.

Referring to FIG. 1, an electronic device 100 may include a processor 110, a memory 120, and a display 130. The processor 110 may be operatively or electrically connected to the memory 120 and the display 130.

The memory 120 may store the respective specific factor values (e.g., image qualities and inches) of a plurality of products. The memory 120 may store instructions for controlling the processor 110.

The processor 110 may set the plurality of products into a plurality of product groups (e.g., a 80-inch FHD TV group, a 75-inch UHD TV group, a 70-inch PHD TV group, and a 65-inch QLED TV group) based on the respective specific factor values (e.g., image qualities and inches) of the plurality of products (e.g., TVs). Each product group may include at least one product. Product group may also be referred to as a product set.

According to an embodiment, designated specific factors may be used as references for data analysis. The specific factors may be set depending on product types. At least two or more specific factors may be designated for one product type. A plurality of products may be placed into a plurality of product groups based on the specific factors. For example, if the product type is a TV type, some (e.g., image quality or inches) among other factors related to the TV specifications may be designated as specific factors for data analysis.

Each of the specific factors may be an ordering factor (e.g., image quality or inches) to classify the plurality of products (e.g., TVs) according to the specs. Here, each ordering factor may represent an ordinal feature (or relative rankings) of the product. Specifically, a user may decide to purchase a product based on relative rankings of the specific factors. For example, a TV with a higher image quality may be ranked higher than a TV with lower image quality, and the user may decide to buy the higher image quality TV based on the specific factor “image quality.”

The concept of ordering factor is described below in greater detail. As an example, if the product type is the TV type, among factors related to the TV specifications, image quality (resolution), inches (screen size), model name, speed, and other factors may be vary in value over time or as the product line-up evolves from a lower to higher-specs, and a series of factor values may be assigned an order. Hence, among TV-related factors, such as image quality, inches, model name, and speed, may be used as ordering factors. Among the above factors, factors which cannot be assigned an order, such as color, service area, product appearance, or service kind, may be excluded from ordering factors.

The plurality of product groups may be sorted in order based on each or a combination of the ordering factor values, such as image quality values or inches. Data analysis may be performed based on at least two or more ordering factors. For data analysis purposes, at least two or more ordering factors may be used as references for dividing the plurality of products into a plurality of product groups.

The processor 110 may set the plurality of product groups into a plurality of segments based on comparison between the plurality of product groups. Setting segments may be referred to as clustering. By clustering, the segment corresponding to each product or each product group may be allocated. Each segment may include at least one product or product group.

According to an embodiment, the plurality of segments may be divided depending on product specs levels. For example, when the plurality of segments are divided into a first segment, a second segment, and a third segment, the first segment, the second segment, and the third segment may correspond to the highest-specs, the medium-specs, and the lowest-specs of the products, respectively.

The segment in which one product or one product group belongs may denote the current position of the product or product group on the market (e.g., the status on the market depending on the product specifications). For example, the segment in which the specific product belongs may be determined depending on the spec level of the specific product relative to target products which are now commercially available.

The segment in which a product or product group belongs may differ over time. For example, a specific product group (e.g., a 50-inch FHD TV group) may be classified as belonging to a zero-ranking segment (e.g., the highest-specs) at a first time (e.g., January of a certain year). If a predetermined time passes and new, higher-specs products are released, clustering may be again performed so that the same product group is re-classified as belonging to a first-ranking segment (e.g., a medium-specs) at a second time (e.g., July of the same year).

The processor 110 may generate forecast data by processing prior time-series data based on the result of clustering. Specifically, the prior time-series data may be prior sell-out data or prior seasonality data, and the forecast data may be forecast sell-out data or forecast seasonality data.

To generate forecast data, the processor 110 may identify per-segment information for the plurality of segments. For example, the per-segment information may be at least one of a correction factor set for each segment, a weight or seasonality factor per segment. According to an embodiment, the per-segment information may be previously stored. Alternatively, the per-segment information may be obtained based on the prior time-series data. For example, the processor 110 may convert per-product prior time-series data (e.g., past sell-out data) for some legacy products, not brand-new ones, of the plurality of products into per-segment data and then extract per-segment information (e.g., at least one of the per-segment correction factor, weight, or seasonality factor) from the per-segment data.

The processor 110 may generate forecast data by processing the prior time-series data based on the per-segment information. Demand forecasting is performed per segment, so that the forecast data may be generated. For example, the prior time-series data or forecast data may be in the form of sell-out data or seasonality data. As another example, the prior time-series data or forecast data may be data in another form of data which may be clustered into segments and be processed among the time-series data. Furthermore, the prior time-series data may be past sell-out data or past seasonality data related to legacy product(s) or product group(s). The forecast data may be the result of processing the prior time-series data based on the result of clustering. The forecast data may include at least part of brand-new time-series data generated based on the result of clustering and the prior time-series data.

According to an embodiment, the segment in which a specific product belongs may be set to differ based on time. If the segment classification is varies, despite the same product or product group, the result of data forecasting may vary depending on which segment the product or product group corresponds to. For example, if a specific product group (e.g., a 80-inch FHD TV group) is classified as belonging to a first segment (e.g., the highest-specs level), the forecast data (e.g., forecast sell-out data) of the product group may correspond to the prior time-series data (e.g., past sell-out data) of the past first segment or the prior time-series data (e.g., the past sell-out data) of the product or product group, which used to belong to the past first segment. If the same product group is classified as belonging to a second segment (e.g., the medium-specs level), the forecast data (e.g., forecast sell-out data) of the product group may correspond to the prior time-series data (e.g., past sell-out data) of the past second segment or the prior time-series data (e.g., the past sell-out data) of the product or product group, which used to belong to the past second segment.

The forecast data may be generated in such a manner as to process the prior time-series data based on, at least, the per-segment information.

The per-segment information including at least one of a correction factor set for each segment, such as a weight or seasonality factor, may be stored.

The per-segment information may be set based on the prior time-series data. Specifically, the prior time-series data may include at least one of per-product data for some of the plurality of products, per-product group data for some of the plurality of product groups, and per-segment data for a plurality of preset segments.

According to an embodiment, the prior time-series data, as past actual sell-out data (or seasonality data extracted therefrom), may include per-product data or per-product group data for legacy product(s) or legacy product group(s). For example, the per-product group data may be data which results from summating the actual sell-out data for the products belonging to the product group.

The prior time-series data may be per-product data during a segmented period (e.g., one quarter or one year). The forecast data may be data during a summated period (e.g., four quarters or two years) corresponding to a multiple segmented periods and may include at least one of the per-product data, per-product group data, or per-segment data.

The prior time-series data may include per-product (or per-product group) time-series data during a first period (e.g., three months) before a specific time (e.g., the current time). The forecast data may include per-segment time-series data during a second period (e.g., one year) after the specific time (e.g., the current time). The second period may be set to be longer than the first period.

According to an embodiment, the processor 110 may generate forecast data (e.g., forecast sell-out data or forecast seasonality data) based on the per-segment information and the prior time-series data (e.g., past sell-out data or past seasonality data). For example, the processor 110 may generate first forecast data (e.g., per-segment forecast seasonality data for the next year) based on the prior time-series data (e.g., per-product actual sell-out data for this year) and then apply per-segment information (e.g., at least one of the correction factor, weight, and seasonality factor per segment), thereby generating second forecast data which is the result of supplementing the first forecast data.

The processor 110 may display at least part (e.g., at least one, or part, of the per-product data, per-product group data, or per-segment data) of the generated forecast data through the display 130. The processor 110 may be configured to display at least part of the forecast data on the display 130.

According to an embodiment, the processor 110 may reset the plurality of product groups and the plurality of segments based on an update (e.g., adding a new product or deleting a legacy product) on the plurality of products. For example, the processor 110 may perform clustering periodically or as at least one brand-new product is released, thereby resetting the product groups and segments. The processor 110 may generate the forecast data for the updated products based on the reset per-segment information.

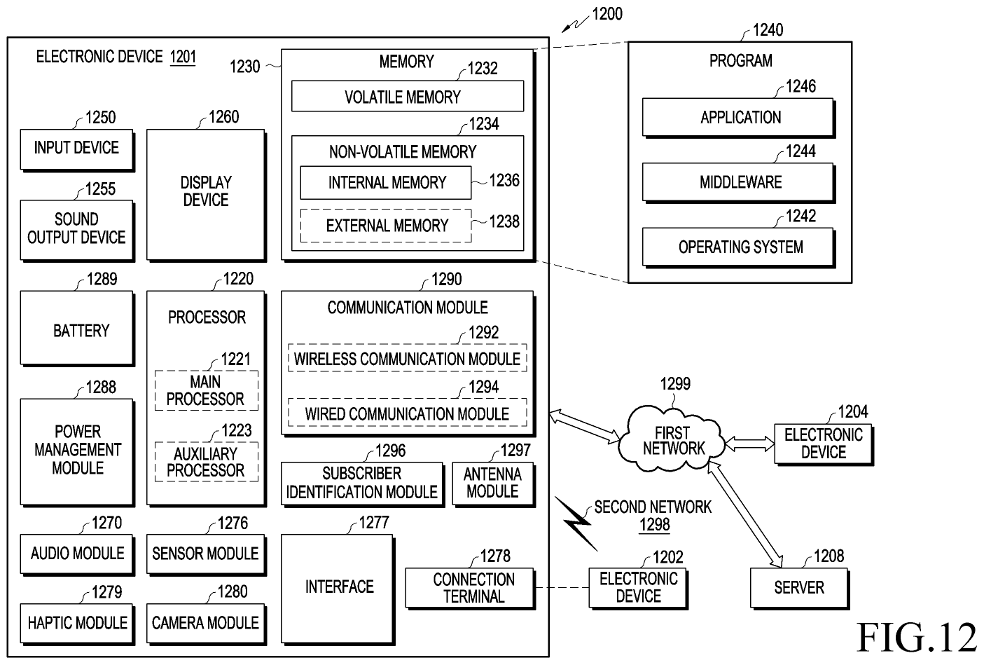

The electronic device 100 may include the whole or part of the electronic device 1201 shown in FIG. 12. For example, the processor 110, memory 120, and display 130 of the electronic device 100 may correspond to the processor 1220, memory 1230, and display device 1260, respectively, of the electronic device 1201 shown in FIG. 12.

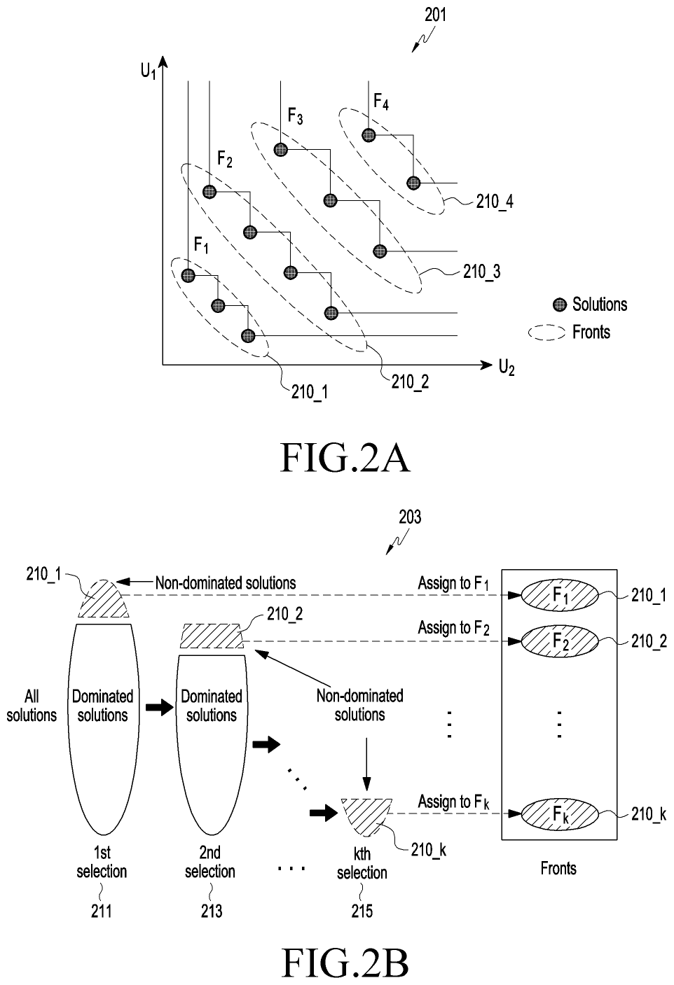

FIGS. 2A and 2B are views 201 and 203 illustrating a clustering rule according to an embodiment.

Clustering or dividing a plurality of products or product groups into a plurality of segments may be performed based on at least two or more specific factors and a designated clustering rule (or clustering algorithm). Each of the specific factors may be an ordering factor.

The clustering algorithm may be intended to select optimal segments for the plurality of products or product groups and have the following features.

First, n (e.g., two or more) product-related ordering factors may be used to create an n+1-dimensional matrix.

Second, the non-dominated sets of products may be sorted.

Third, the non-dominated sets may be clustered into k clusters (segments). Each cluster may represent a relative strength (e.g., market status) of the product on the market.

FIGS. 2A and 2B illustrate a Pareto optimality (or Pareto efficiency) algorithm as an applicable clustering algorithm according to an embodiment. The electronic device 100 may obtain an optimal product distribution state, which leaves no room for further enhancement, by the Pareto optimality algorithm.

FIG. 2A illustrates an example population with 12 solutions and four Pareto fronts. If two utilities, U1 and U2, are given, a total of four Pareto fronts F1(210_1), F2(210_2), F3(210_3), and F4(210_4) may be selected as the optimal set for the 12 solutions in the population.

In the example shown in FIG. 2A, the 12 solutions in the population individually or separately correspond to 12 product groups (e.g., TV groups), the utilities U1 and U2 may individually or separately correspond to two ordering factors (e.g., image quality and inches) for clustering, and the Pareto fronts F1(210_1), F2(210_2), F3(210_3), and F4(210_4) may individually or separately correspond to four segments which have optimally been distributed as a result of clustering. The smaller U1 and U2 mean that the better features may be given.

The concept of non-dominated set may be utilized for clustering.

For example, each solution in group F1(210_1) has the smallest U1 value and the smallest U2 value among all of the twelve solutions in the population. There is no solution which has a smaller U2 value and a smaller U1 value than those of the solutions in F1(210_1). Thus, group F1(210_1) is superior to F2(210_2), F3(210_3), and F4(210_4) in all aspects. In this case, the group F1(210_1) may be defined as a non-dominated set. Likewise, group F2(210_2) is superior to group F3(210_3) in all aspects. In such a manner, the solutions in the population may be grouped into groups F1(210_1), F2(210_2), F3(210_3), and F4(210_4).

If U1 and U2 are ordering factors (e.g., image quality or inches) related to product specifications, group F1(210_1) may have the higher specifications over F2(210_2), F3(210_3), and F4(210_4). The specifications levels may be lowered in the order of F2(210_2)>F3(210_3)>F4(210_4). F4(210_4) may have the lower specifications than F1(210_1), F2(210_2), and F3(210_3).

As an example, the electronic device 100 may perform clustering based on the Pareto optimality algorithm. As shown in FIG. 2A, the electronic device 100 may sort the plurality of product groups (e.g., a total of 12 solutions) based on specific factors (e.g., two utilities, U1 and U2, for example, denoting image quality and inches) and then set a plurality of segments (e.g., a total of four fronts F1(210_1), F2(210_2), F3(210_3), and F4(210_4)) as the optimal set for the product groups.

The mathematical theory for the Pareto optimality algorithm is described below.

Unless there are other feasible action sets (\tilde{α}₁,\tilde{α}₂) that meet Equations 1 and 2 with one or more strict inequalities, the set of feasible actions (α₁^{P},α₂^{P}) may be deemed as Pareto optimal.

U₁(\tilde{α}₁,\tilde{α}₂)≥U₁(α₁^{P},α₂^{P}) [Equation 1]

U₂(\tilde{α}₁,\tilde{α}₂)≥U₂(α₁^{P},α₂^{P}) [Equation 1]

In other words, there may be no other allocations that enhance the features of both the utilities U1 and U2 individually or in combination. Any feasible action set (\tilde{α}₁,\tilde{α}₂) may meet Equation 3.

U₁(\tilde{α}₁,\tilde{α}₂)>U₁(α₁^{P},α₂^{P})⇒U₂(\tilde{α}₁,\tilde{α}₂)<U₂(α₁^{P},α₂^{P}) [Equation 1]

FIG. 2B illustrates an example concept of a non-dominated sorting process of the solutions in a population.

An example of clustering is described below.

First, k−1 boundaries resᵢ (Ω) may be determined for k clusters.

Here, time-series data may include trend variation, seasonal variation, and irregular variation components. The trend variation may be a factor indicating that data increases or decreases on a long-term basis or makes no or little change. The seasonal variation may indicate that data varies repeatedly at predetermined cycles in the same or similar pattern. The irregular variation indicates irregular variations which may be regarded as noise.

Time-series signal SOi may be the sum of historical data of the ith cluster. Specifically, resᵢ may be a signal left after the trend, seasonality, and noise have been decomposed from the time-series signal. If the remaining signal of the time-series signal except for the trend and seasonality is close to a random signal, it may be determined that trend and seasonality have been separated well. In other words, as the remaining signal is close to a random signal, data analysis may be regarded more precise and reliable.

Second, resᵢ (Ω) produces the minimum autocorr(resᵢ (Ω)) value that may be obtained based on Equation 4. The autocorr (autocorrelation) function may mean the correlation between resᵢ (Ω) at time t1 (e.g., in the past) and resᵢ (Ω) at time t2 (e.g., at the present time). The boundary set which makes the maximum value of the autocorrelation values of resᵢ the smallest may be designated and used as a reference for determining whether the remaining signal is a random signal.

$${argmin}_{Ω} max ( autocorr ( {res}_{i} ( Ω ) ) \qquad [ Equation 4 ]$$

In the example shown in FIG. 2B, all the solutions in the population may correspond to all the product groups corresponding to a specific product type, and F1(210_1), F2(210_2), . . . , and Fk(210_k) may correspond to the k segments distributed as a result of clustering.

The electronic device 100 may sort non-dominated sets in order from the plurality of product groups based on comparison between the plurality of product groups and set the non-dominated sets into a plurality of segments. Each non-dominated set may include at least one product group which corresponds to the highest specifications among the target product groups. 10107j As an example, the non-dominated set 210_1 of a first selection (211) among all the solutions (or product groups) may be assigned as the first segment F₁ (210_1). The non-dominated set 210_2 of a second selection (213) among the remaining solutions may be assigned as the second segment F₂ (210_2). The non-dominated set 210_k of a k-th selection (215) among the remaining solutions may be assigned as the k-th segment Fₖ (210_k). As such, the non-dominated sets may be sorted in order and set as segments.

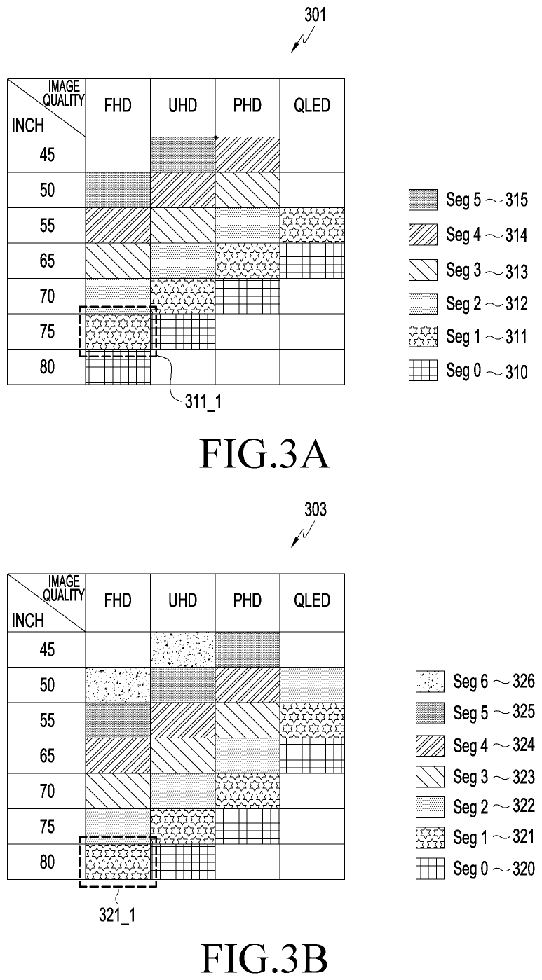

FIGS. 3A and 3B are reference views 301 and 303 illustrating the concept of clustering according to an embodiment.

“Clustering” may refer to setting or determining a plurality of segments. As an example, clustering may be performed by the electronic device 100 or processor 110 of FIG. 1. In clustering, a segment corresponding to each of a plurality of products or product groups may be set based on a designated clustering rule.

FIGS. 3A and 3B illustrate an example in which the product type is a TV type, the product is a TV, and image quality and inches are designated as specific factors for clustering. As an example, the image quality value may be at least one of FHD, UHD, PHD, and QLED. The inches may be at least one of 45 inches, 50 inches, 55 inches, 65 inches, 70 inches, 75 inches, and 80 inches. However, the image quality value and the inches are not limited hereto.

The electronic device 100 may sort the plurality of product groups based on specific factors as shown in FIG. 3A or 3B. After sorting the plurality of product groups based on the specific factors, the electronic device 100 may set the plurality of product groups into a plurality of segments based on comparison between the plurality of product groups.

FIGS. 3A and 3B illustrate example results of clustering at two different times. Clustering may be performed based on non-dominated sorting by the Pareto optimality algorithm.

In the example shown in FIG. 3A, the product group set to the zero-ranking segment (Seg 0) 310 corresponds to a non-dominated set among all the product groups. The product group set to the first-ranking segment (Seg 1) 311 has one dominated set (Seg 0). The product group set to the second-ranking segment (Seg 2) 312 has two dominated sets (Seg 0 and Seg 1). The product group set to the nth-ranking segment (in the case of FIG. 3A, n=5, the fifth-ranking segment (Seg 5) 315) has n dominated sets (in the case of FIG. 3A, Seg 0, Seg 1, Seg 2, Seg 3, and Seg 4).

The electronic device 100 may extract non-dominated sets from among the target product groups and set the extracted non-dominated sets into segments.

If there is no product group that enhances all conditions (e.g., image quality and inches) related to given specific factors as compared with a specific product group, the specific product group may be set to a non-dominated set.

In the example shown in FIG. 3A, if there is no product group for which image quality and inches get better or larger as compared with the first product group among all the product groups, the first product group (e.g., 80-inch FHD, 75-inch UHD, 70-inch PHD, and 65-inch QLED of FIG. 3A) may be classified as belonging to a non-dominated set, and the non-dominated set may be set to the zero-ranking segment (Seg 0) 310. For example, the product groups corresponding to the highest specifications, (FHD image quality, 80 inches), (UHD image quality, 75 inches), (PHD image quality, 70 inches), (QLED image quality, 65 inches), may be set to the zero-ranking segment 310 based on comparison between the plurality of product groups.

If there is no product group for which image quality and inches get better or larger as compared with the second product group among all the remaining product groups except for the first product group, the second product group (e.g., 75-inch FHD (311_1), 70-inch UHD, 65-inch PHD, and 55-inch QLED of FIG. 3A) may be classified again as a non-dominated set, and the non-dominated set may be set to the first-ranking segment (Seg 1) 311. As an example, the product groups corresponding to the highest specifications, (FHD image quality, 75 inches), (UHD image quality, 70 inches), (PHD image quality, 65 inches), (QLED image quality, 55 inches), among the remaining product groups may be set to the first-ranking segment 311 based on comparison between the remaining product groups.

The zero-ranking segment (Seg 0) 310, the first-ranking segment (Seg 1) 311, the second-ranking segment (Seg 2) 312, the third-ranking segment (Seg 3) 313, the fourth-ranking segment (Seg 4) 314, and the fifth-ranking segment (Seg 5) 315 may be set in accordance with the above-identified manner.

As such, the current product groups belonging to one product type may be sorted based on ordering factor values (e.g., image quality value and inches) and, then, the segments individually or separately corresponding to the product groups may be sequentially allocated based on comparison between the current product groups sorted.

The products included in one product type may be updated over time. For example, in the case of mobile phones, a brand-new model may be added or legacy models may be discontinued every quarter or year. In other words, the highest-spec models may be newly launched or the lowest-spec models may be discontinued.

In such a case, the target products may be updated and, as the products are updated, clustering may be performed again, resetting the product groups and segments.

While FIG. 3A illustrates an example result of clustering at a first time (e.g., in March or the last year), FIG. 3B may illustrate an example result of clustering at a second time (e.g., in June or this year). As an example, the segments at the second time may be the result of a shift in some of the segments at the first time.

Referring to FIG. 3B, as the products are updated, the target product groups are sorted again based on specific factors (e.g., image quality and inches) and then the product groups may be reset to a plurality of segments (Seg 0 to Seg 6). As an example, if there is no product group for which image quality and inches of the plurality of products get better or larger among the target product groups based on comparison between the product groups, the specific product group may be classified as belonging to the zero-ranking segment (Seg 0) 320. In the case of FIG. 3B, the product groups corresponding to (UHD image quality, 80 inches), (PHD image quality, 75 inches), and (QLED image quality, 65 inches), may be set to the zero-ranking segment 320.

If there is no product group for which image quality and inches get better or larger, as compared with the specific product group, among the remaining product groups except for the zero-ranking segment 320, the specific product group may be classified as belonging to the first-ranking segment (Seg 1) 321. In the case of FIG. 3B, (FHD image quality, 80 inches), (UHD image quality, 75 inches), (PHD image quality, 70 inches), (QLED image quality, 55 inches), may be set to the first-ranking segment 321.

The zero-ranking segment (Seg 0) 320, the first-ranking segment (Seg 1) 321, the second-ranking segment (Seg 2) 322, the third-ranking segment (Seg 3) 323, the fourth-ranking segment (Seg 4) 324, the fifth-ranking segment (Seg 5) 325, and the sixth-ranking segment (Seg 6) 326 may be set in accordance with the above-identified manner.

As such, the current product groups belonging to one product type may be sorted based on ordering factor values and, then, the segments corresponding to the product groups may be sequentially set based on comparison between the product groups.

Referring to FIGS. 3A and 3B, even the same product or product group may be set to different segments over time. As an example, a 75-inch FHD TV group 311_1 may be classified as belonging to the first-ranking segment 311 at the first time as shown in FIG. 3A and be classified as belonging to the second-ranking segment 322, which is ranked lower than the first-ranking, at the second time as shown in FIG. 3B. As another example, a 80-inch FHD TV group 321_1 may be classified as belonging to the zero-ranking segment 310 at the first time as shown in FIG. 3A and be classified as belonging to the first-ranking segment 321, which is ranked lower than the zero-ranking, at the second time as shown in FIG. 3B.

Since the higher-spec products are released into the market over time, the segment ranking of a specific product or product group may be lowered. That is, as the segment corresponding to the same product or product group becomes old over time, forecast data (e.g., forecast sell-out data) for the product or product group may differ over time. For example, the 80-inch FHD TV group 321_1 is set to the first-ranking segment 321 at the second time (e.g., the present time). Hence, the forecast data (e.g., forecast sell-out data) may be forecasted corresponding to the prior time-series data (e.g., past sell-out data) for the 75-inch FHD TV group 311_1 which is the first-ranking segment 311 at the first time (e.g., in the past).

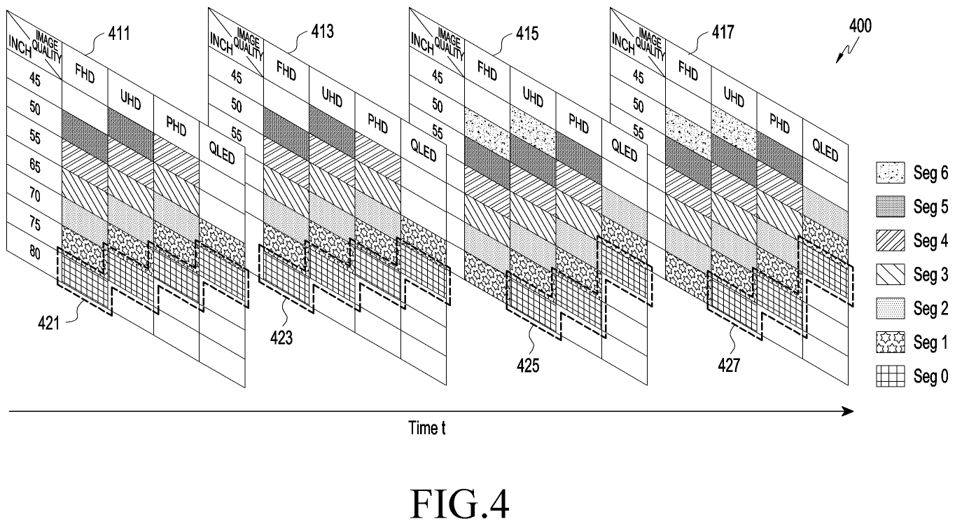

FIG. 4 is a view 400 illustrating an example variation in clustering according to an embodiment.

FIG. 4 shows examples of the results of clustering 411, 413, 415 and 417 over time t.

As an example, clustering may be performed at periodic intervals. As another example, clustering may be performed based on a user input. As another example, clustering may be performed whenever a product update occurs. As another example, clustering may be performed whenever a predetermined number of products are varied. That is, when a predetermined number of products are added or deleted due to new product release or end of production, clustering may be performed.

As shown, the product groups individually or separately belonging to the segments may be altered over time. As an example, the product groups in the zero-ranking segment may be varied in the order of 421→423→425→427.

Clustering to determine segments may be performed in such a manner as to allocate segments individually or separately corresponding to the current product groups based on sorting of the current product groups or comparison between the current product groups.

Products (e.g., TV models) in one product type may be updated (or varied, e.g., products added or deleted) over time. As the products are updated, clustering may be performed so that the product groups and segments corresponding to the updated products may be reset.

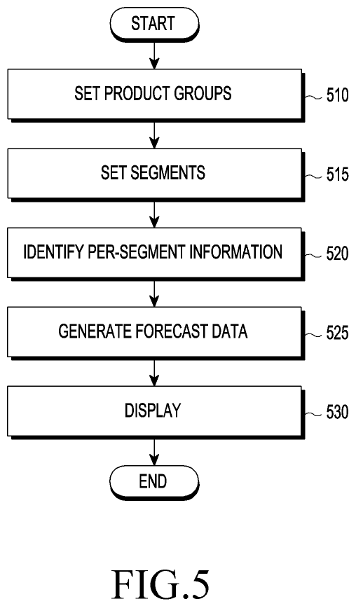

FIG. 5 is a flowchart illustrating a data forecasting analysis operation according to an embodiment.

In operation 510, the electronic device 100 may set a plurality of products into a plurality of product groups based on the respective specific factor values of the plurality of products. According to an embodiment, each of the specific factor values may be an ordering factor for classifying the plurality of products according to specifications. The specific factors may be set depending on product types.

Alternatively, operation 510 may be replaced with sorting the plurality of products based on the respective specific factor values of the plurality of products.

In operation 515, the electronic device 100 may perform clustering to set the plurality of product groups into a plurality of segments based on comparison between the plurality of products. Which segment a product group (or product) currently belongs to may be determined depending on the position (or status) of the product group if all target product groups are sorted based on specific factors. Which segment a specific product belongs to may be set to differ over time.

The electronic device 100 may set the plurality of product groups into the plurality of segments based on a designated clustering rule. For example, upon setting the plurality of product groups into the plurality of segments, the electronic device 100 may sequentially sort non-dominated sets from the plurality of product groups based on comparison between the plurality of product groups and set the non-dominated sets into a plurality of segments. If a plurality of product groups (or products) are clustered to set a plurality of segments based on specifications of products, the non-dominated set may include at least one product group which has the highest value for all of a plurality of ordering factors designated in relation to the specifications among all the target product groups. The electronic device 100 may compare the plurality of product groups using the ordering factor values and classify at least one top-ranking product group among the plurality of product groups as the first segment. The electronic device 100 may again compare the remaining product groups using the ordering factor values and classify the next top-ranking product group among the remaining product groups as the second segment. Such process may be repeated on all the target product groups, thereby sequentially sorting the non-dominated sets based on relative rankings of the products.

In operation 520, the electronic device 100 may identify per-segment information for the plurality of segments. For example, the per-segment information may be at least one of a correction factor, a weight, and a seasonal factor set for each segment. The per-segment information may be information previously stored or may be obtained upon clustering. The per-segment information may be set based on the prior time-series data. For example, the electronic device 100 may convert past per-product sell-out data into per-segment sell-out data or may load the past per-segment sell-out data and then extract the correction factor, weight, or seasonality factor for each segment from the per-segment sell-out data. The prior time-series data may mean actual sell-out data. The prior time-series data may include at least one of per-product data (e.g., past sell-out data or seasonality data for each legacy product) for some of a plurality of products, per-product group data (e.g., past sell-out data or seasonality data for each legacy product group) for some of a plurality of product groups, and per-segment data (e.g., past sell-out data or seasonality data for each segment) for a plurality of preset segments.

As an example, the per-product group data may be data which results from summating the sell-out data of the products belonging to each product group and representing the same per product group. The per-segment data may be data resulting from converting the sell-out data of product groups (or products) into segment units based on the correlation between the segment and the product groups (or products) belonging to the segment.

An example of identifying per-segment information based on prior time-series data is described below.

The electronic device 100 may identify prior time-series data for some (legacy products except for newly added products) of a plurality of products. The electronic device 100 may also identify prior time-series data for some (e.g., product groups corresponding to legacy products) of a plurality of product groups. The electronic device 100 may convert the prior time-series data for some of the products or product groups into per-segment data and extract each piece of per-segment information (e.g., at least one of the correction factor, weight, or seasonality factor).

In operation 525, the electronic device 100 may generate forecast data by processing the prior time-series data based on the per-segment information.

Specifically, the prior time-series data may be prior sell-out data or prior seasonality data, and the forecast data may include sell-out data or forecast seasonality data.

For example, the electronic device 100 may identify a specific segment (e.g., the highest-spec level) where a first product (or first product group) among a plurality of segments currently set belongs. The electronic device 100 may extract information (e.g., at least one of the correction factor, weight, and seasonality factor) for the specific segment from prior time-series data (e.g., past sell-out data). The electronic device 100 may reconfigure seasonality data for the first product (or first product group) belonging to the specific segment based on information for the specific segment and generate forecast data (e.g., forecast sell-out data) at the current time, with the reconfigured seasonality data applied thereto.

The forecast data may be at least one of per-segment data, per-product group data, or per-product data. As an example, the forecast data may be forecast sell-out data which represents a variation in the sell-out quantity over time or seasonality data extracted from the forecast sell-out data.

According to an embodiment, the prior time-series data may include data for a segmented period (e.g., one quarter or year). The forecast data may include data for a summated period (e.g., four quarters or two years) corresponding to a multiple segmented periods. According to an embodiment, the prior time-series data may include time-series data for a first period (e.g., a predetermined past period) before a specific time (e.g., the present time). The forecast data may include time-series data for a second period (e.g., a predetermined future period) after the specific time (e.g., the present time). The second period may be longer than the first period.

In operation 530, the electronic device 100 may display at least part of the generated forecast data (e.g., at least part of the forecast data or data extracted and processed from the forecast data) on the display.

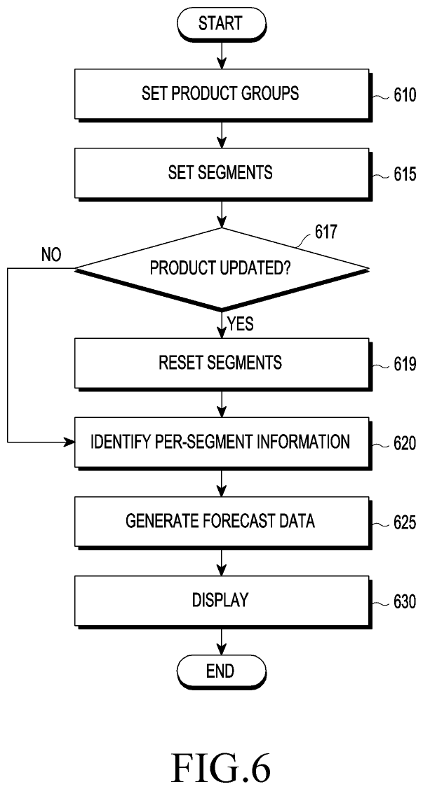

FIG. 6 is a flowchart illustrating a data forecasting analysis operation according to an embodiment.

Operations 610, 615, 620, 625, and 630 may correspond to operations 510, 515, 520, 525, and 530, respectively, in FIG. 5.

In operation 617, the electronic device 100 may identify whether a plurality of products are updated (e.g., a new product added or legacy product deleted). The operation 617 may be performed at each cycle, when a product update occurs, when a predetermined number of products are updated, or when a data analysis event occurs.

In operation 619, the electronic device 100 may perform clustering again based on an update on the plurality of products, resetting the plurality of preset product groups and segments.

In operation 620, the electronic device 100 may identify per-segment information for the plurality of reset segments.

In operation 625, the electronic device 100 may generate forecast data by processing prior time-series data based on the respective pieces of per-segment information for the plurality of reset segments.

In operation 630, the electronic device 100 may display at least part of the generated forecast data.

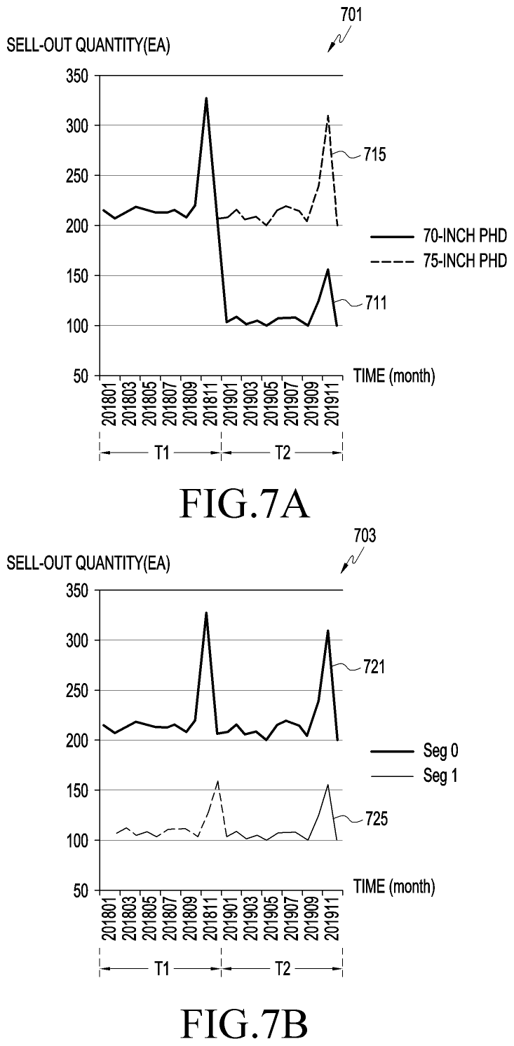

FIGS. 7A and 7B are graphs 701 and 703 illustrating results of data forecasting analysis according to an embodiment.

FIG. 7A illustrates a variation in sell-out quantity over time, as an example of product sell-out time-series data before clustering applies.

Specifically, sell-out data 711 and 715 indicate examples of per-product sell-out data for products such as a 70-inch PHD TV and a 75-inch PHD TV, respectively. The sell-out data 711 indicates example sell-out data for a first product (e.g., a 70-inch PHD TV). The sell-out data 715 indicates example sell-out data for a second product (e.g., a 75-inch PHD TV).

The sell-out data for a first period T1 may be past sell-out data (actual sell-out data). The sell-out data for the second period T2 may be forecast sell-out data. For example, the 75-inch PHD is newly released after the first period T1 elapses. Since the 75-inch PHD was not in the market during the first period T1, there is no 75-inch PHD past sell-out data for the first period T1.

If the 75-inch PHD TV is newly released, the user may set the 75-inch PHD TV as a premium level product based on the specification of the 75-inch PHD TV compared to the legacy 70-inch PHD TV. Thus, the result of sell-out quantity forecast for the 75-inch PHD TV for the second period T2 may be shown to be similar to the actual sell-out quantity for the 70-inch PHD TV for the first period T1. Further, the 70-inch PHD TV may be set as an entry-level product which is one-step lower than the premium level, and the lowered sell-out quantity forecast result for the second period T2 may be shown as indicated with the sell-out data 711.

As such, if data analysis is performed based on products, subjective factors may be involved when the user manually sets the grade of the product whenever a new product is released, thereby deteriorating the accuracy of data analysis.

In the case of products (e.g., new-released products, such as the 75-inch PHD of FIG. 7A) for which there is no past sell-out data for a sufficient period, it may be hard to obtain a reliable analysis result.

Data analysis limited to product units may be restrictively applied only to specific products or models and its expandability may be limited.

FIG. 7B illustrates an example of product sell-out time-series data after the clustering is applied. FIG. 7B illustrates a variation in sell-out quantity for each segment over time when segments are allocated as shown in FIG. 3A.

The sell-out data 721 and 725 indicate example per-segment sell-out data for segments. The sell-out data 721 indicates example sell-out data for the zero-ranking segment (e.g., the zero-ranking segment 310 of FIG. 3A). The sell-out data 725 indicates example sell-out data for the first-ranking segment (e.g., the first-ranking segment 311 of FIG. 3A).

The sell-out data 721 for the zero-ranking segment may be shown in the form of a combination of the sell-out data for the product group allocated as the zero-ranking segment for the first period T1 and the sell-out data for the product group allocated as the zero-ranking segment for the second period T2.

The sell-out data 725 for the first-ranking segment may be shown in the form of a combination of the sell-out data for the product group allocated as the first-ranking segment for the first period T1 and the sell-out data for the product group allocated as the first-ranking segment for the second period T2.

As such, if data analysis is performed based on segments by way of clustering, subjective factors may be excluded, and thus, objective and precise product sorting may be rendered, and the accuracy of data analysis may be significantly enhanced.

Further, even for products whose market cycle is short and which lack prior time-series data for a sufficient period, a reliable analysis result related to demand forecasting may be obtained by segment allocation.

Further, segment-based data analysis using clustering does not depend on individual products or specific models but may rather apply to various products or models with a short market cycle. Thus, expandability may be reinforced.

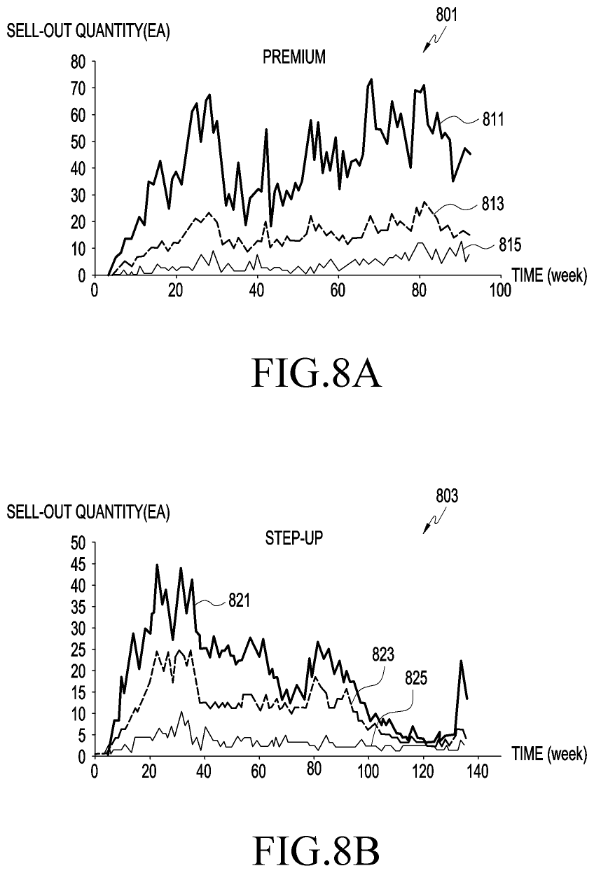

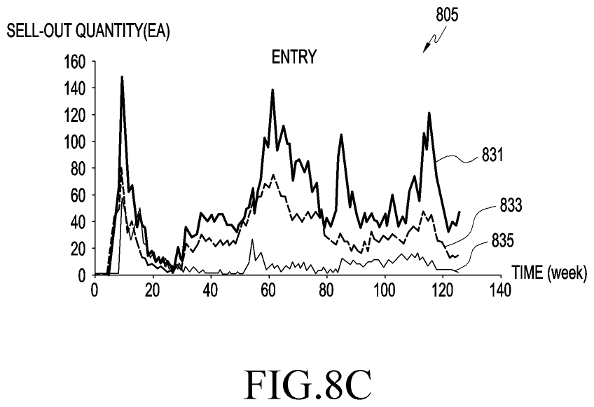

FIGS. 8A, 8B, and 8C are graphs 801 and 803 illustrating results of data forecasting analysis according to an embodiment.

The data forecasting analysis 801 of FIG. 8A indicates example sell-out data for premium product groups belonging to the zero-ranking segment (e.g., the zero-ranking segment 320 of FIG. 3B).

The sell-out data 811 indicates example sell-out data for a first product group (e.g., the 65-inch QLED TV group of FIG. 3B) allocated to the zero-ranking segment (e.g., the zero-ranking segment 320 of FIG. 3B). The sell-out data 813 indicates example sell-out data for a second product group (e.g., the 75-inch PHD TV group of FIG. 3B) allocated to the zero-ranking segment. The sell-out data 815 indicates example sell-out data for a third product group (e.g., the 80-inch UHD TV group of FIG. 3B) allocated to the zero-ranking segment.

As an example, the electronic device 100 may obtain more precise, reliable time-series sell-out data in such a manner as to generate sell-out data which is a combination of forecast sell-out data and past sell-out data for the first product group and then compensate for the sell-out data based on information (e.g., at least one of the correction factor, weight, or seasonality factor) set for the zero-ranking segment.

The data forecasting analysis 803 of FIG. 8B indicates example sell-out data for step-up product groups belonging to the first-ranking segment (e.g., the first-ranking segment 321 of FIG. 3B).

The sell-out data 821 indicates example time-series sell-out data for the first product group allocated to the first-ranking segment. The sell-out data 823 indicates example time-series sell-out data for the second product group allocated to the first-ranking segment, and the sell-out data 825 indicates example time-series sell-out data for the third product group allocated to the first-ranking segment.

The data forecasting analysis 805 of FIG. 8C indicates example sell-out data for entry-level product groups belonging to the second-ranking segment.

The sell-out data 831 indicates example time-series sell-out data for the first product group allocated to the second-ranking segment. The sell-out data 833 indicates example time-series sell-out data for the second product group allocated to the second-ranking segment. The sell-out data 835 indicates example time-series sell-out data for the third product group allocated to the second-ranking segment.

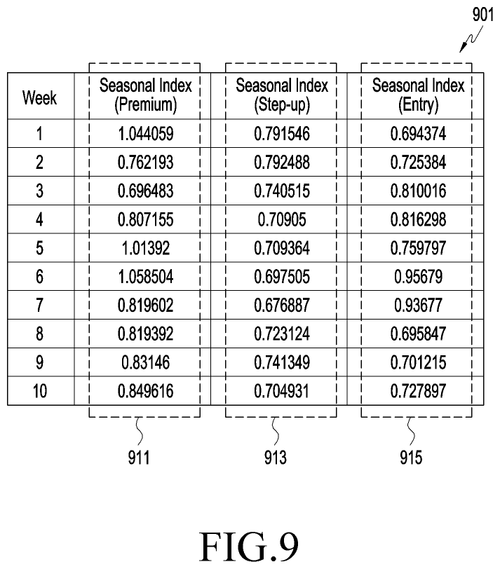

FIG. 9 is a table 901 illustrating results of analysis of seasonal data according to an embodiment.

The electronic device 100 may extract seasonality data, as shown in FIG. 9, from time-series sell-out data, as shown in FIGS. 8A to 8C. As an example, the seasonality data may include seasonal indexes depending on time (per week).

The seasonal index (premium) 911 may be seasonality data extracted from the time-series sell-out data for the premium product groups of FIG. 8A. The seasonal index (step-up) 913 may be seasonality data extracted from the time-series sell-out data for the step-up product groups of FIG. 8B. The seasonal index (entry) 915 may be seasonality data extracted from the time-series sell-out data for the entry-level product groups of FIG. 8C.

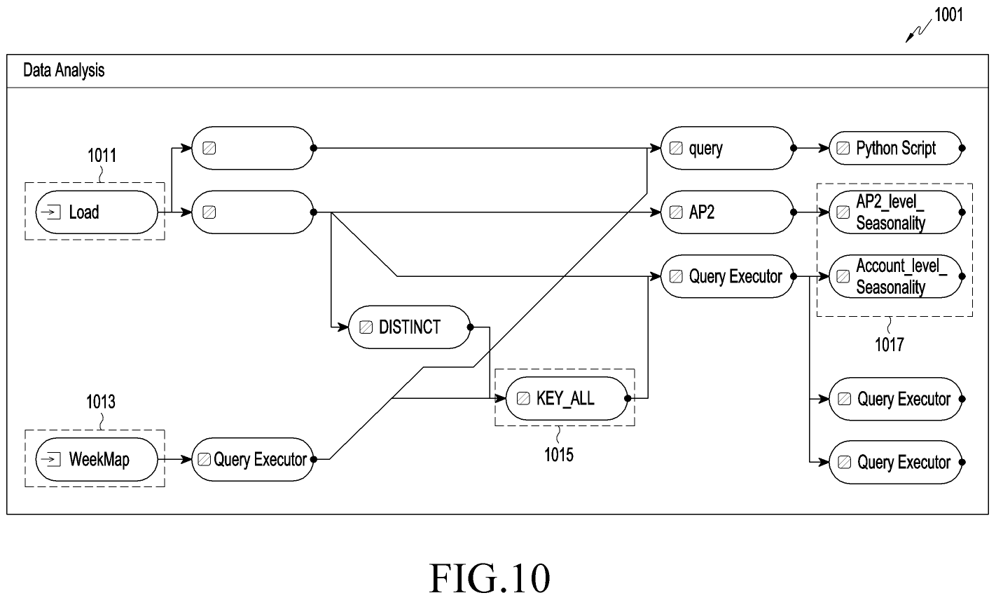

FIG. 10 is a view illustrating an example screen for performing data forecasting analysis according to an embodiment. FIG. 10 illustrates an example user interface screen 1001 of a data analysis tool.

The data analysis tool may be used to obtain new seasonality data reconfigured based on the result of clustering. For example, the data analysis tool may be installed on an electronic device (e.g., the electronic device 100 of FIG. 1 or the electronic device 1201 of FIG. 12) or an external electronic device (e.g., the electronic device 1202 of FIG. 12) connected with the electronic device.

The user interface screen 1001 of the data analysis tool may include at least one of a first area 1011, a second area 1013, a third area 1015, and a fourth area 1017.

A first menu may be displayed on the first area 1011. The first menu may be a menu for fetching existing time-series data. Specifically, the time-series data may correspond to past sell-out data or seasonality data extracted from the past sell-out data. For example, the time-series data may be weekly sell-out data for the whole last year for each of the 70-inch PHD TV and 75-inch PHD TV or seasonality data extracted from the weekly sell-out data.

A second menu may be displayed on the second area 1013. The second menu may be a menu for fetching time-series reference information (e.g., at least one of pieces of information about the date, week, month, year, unit, calendar, or schedule) necessary for time-series analysis. As an example, the time-series reference information may be stored in the form of a lookup table. The time-series reference information may be information related to variables necessary for time-series analysis. The time-series reference information may be information for setting time units or time intervals (e.g., the weekly interval in FIGS. 8A to 8C or the monthly interval of FIGS. 7A and 7B) used for time-series analysis. The time-series reference information may include at least one piece of information about how many weeks each month of the last year and this year has, when the sell-out quantity drastically increases or decreases (e.g., the week or month related to Black Friday), what month a specific week (e.g., the 25th week of this year) corresponds to, or when demand forecasting is needed.

A third menu may be displayed on the third area 1015. The third menu may be a menu for mapping the time-series reference information and existing time-series data. If the unit of the existing time-series data differs from the unit necessary for time-series analysis, the unit of the existing time-series data may be converted. The data analysis tool may undergo a task of converting the existing time-series data into designated time units (e.g., weekly units). The existing time-series data of dates or monthly units may be converted into continuous weekly unit data to fit the units set in the time-series reference information.

A fourth menu for obtaining and outputting seasonality data may be displayed on the fourth area 1017. Upon selecting the fourth menu, clustering may be performed and, based on the result of clustering, new seasonality data may be reconfigured. As an example, the data analysis tool may reconfigure new seasonality data (e.g., the per-segment data of FIGS. 7B and 8A to 8C) from the seasonality data (e.g., the per-month data or per-week data of FIG. 7A) corresponding to the existing time-series data using the result of clustering. The new seasonality data may include data of a plurality of different levels (e.g., a lower level (per store) and a higher level (per district or country). As an example, the new seasonality data may include seasonality data per store and seasonality data per district or country. Data corresponding to the new seasonality data (e.g., forecast sell-out data with the new seasonality data applied thereto) may be output and displayed.

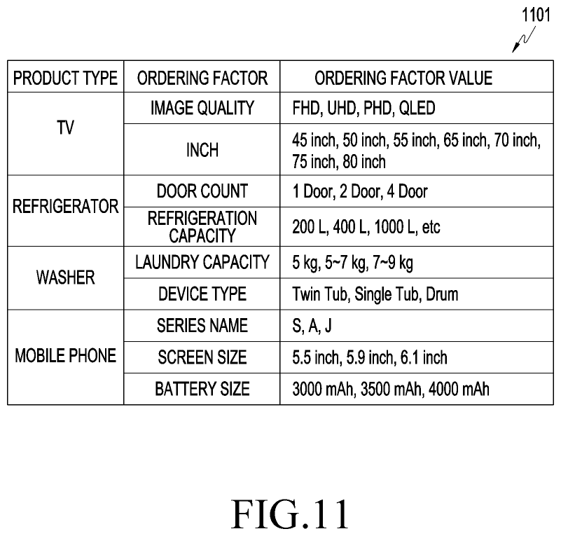

FIG. 11 is a table 1101 illustrating ordering factors per product type according to an embodiment.

The specific factors for clustering may be determined depending on product types.

As an example, if the product type is a TV type, image quality and inches may be used as ordering factors for clustering.

As another example, if the product type is a refrigerator type, door count and refrigerating capacity may be used as ordering factors for clustering.

As another example, if the product type is a washer type, washing capacity and equipment type may be used as ordering factors for clustering.

As another example, if the product type is a mobile phone type, the series name, screen size, and battery size may be used as ordering factors for clustering.

According to an embodiment, an electronic device (e.g., the electronic device 100 of FIG. 1 or the electronic device 1201 of FIG. 12) may include a display (e.g., the display 130 of FIG. 1 or the display device 1260 of FIG. 12), a memory (e.g., the memory 120 of FIG. 1 or the memory 1230 of FIG. 12), and a processor operatively connected with the display and the memory. The memory may store executable instructions causing the processor to set a plurality of products into a plurality of product groups based on respective specific factor values of the plurality of products, set the plurality of product groups into a plurality of segments based on comparison between the plurality of product groups, identify per-segment information for the plurality of segments, generate forecast data by processing prior time-series data based on the per-segment information, and display at least part of the forecast data through the display.

According to an embodiment, each of the specific factor values may be an ordering factor for classifying the plurality of products according to a specification.

According to an embodiment, which segment a specific product belongs to may be set to differ depending on time.

According to an embodiment, the specific factors may be set depending on product types.

According to an embodiment, the instructions may control the processor to reset the plurality of product groups and the plurality of segments based on an update on the plurality of products.

According to an embodiment, the per-segment information may include at least one of a correction factor, a weight, and a seasonal factor set for each segment.

According to an embodiment, the per-segment information may be set based on the prior time-series data.

According to an embodiment, the prior time-series data may include data during a segmented period, and the forecast data may include data during a summated period corresponding to multiple segmented periods.

According to an embodiment, the prior time-series data may include time-series data during a first period before a specific time, and the forecast data may include time-series data during a second period after the specific time, and wherein the second period is set to be longer than the first period.

According to an embodiment, the prior time-series data may include at least one of per-product time-series data for some of the plurality of products, per-product group time-series data for some of the plurality of product groups, and per-segment time-series data for a plurality of preset segments.

According to an embodiment, the instructions may control the processor to set the plurality of product groups into the plurality of segments based on a designated clustering rule.

According to an embodiment, the instructions may control the processor to, upon setting the plurality of product groups into the plurality of segments, sequentially classify non-dominated sets from the plurality of product groups based on comparison between the plurality of product groups and set the non-dominated sets into the plurality of segments.

According to an embodiment, a method of data forecast analysis may comprise setting a plurality of products into a plurality of product groups based on respective specific factor values of the plurality of products; setting the plurality of product groups into a plurality of segments based on comparison between the plurality of product groups; identifying per-segment information for the plurality of segments; generating forecast data by processing prior time-series data based on the per-segment information; and displaying at least part of the forecast data through a display.

According to an embodiment, each of the specific factor values may be an ordering factor for classifying the plurality of products according to a specification.

According to an embodiment, which segment a specific product belongs to may be set to differ depending on time.

According to an embodiment, the specific factors may be set depending on product types.

According to an embodiment, the method may further comprise resetting the plurality of product groups and the plurality of segments based on an update on the plurality of products.

According to an embodiment, the per-segment information may include at least one of a correction factor, a weight, or a seasonal factor set for each segment.

According to an embodiment, the per-segment information may be set based on the prior time-series data.

According to an embodiment, the prior time-series data may include data during a segmented period, and the forecast data includes data during a summated period corresponding to a multiple of the segmented period.

FIG. 12 is a block diagram illustrating an electronic device 1201 in a network environment 1200 according to various embodiments. Referring to FIG. 12, the electronic device 1201 in the network environment 1200 may communicate with an electronic device 1202 via a first network 1298 (e.g., a short-range wireless communication network), or an electronic device 1204 or a server 1208 via a second network 1299 (e.g., a long-range wireless communication network). According to an embodiment, the electronic device 1201 may communicate with the electronic device 1204 via the server 1208. According to an embodiment, the electronic device 1201 may include a processor 1220, memory 1230, an input device 1250, a sound output device 1255, a display device 1260, an audio module 1270, a sensor module 1276, an interface 1277, a haptic module 1279, a camera module 1280, a power management module 1288, a battery 1289, a communication module 1290, a subscriber identification module (SIM) 1296, or an antenna module 1297. In some embodiments, at least one (e.g., the display device 1260 or the camera module 1280) of the components may be omitted from the electronic device 1201, or one or more other components may be added in the electronic device 1201. In some embodiments, some of the components may be implemented as single integrated circuitry. For example, the sensor module 1276 (e.g., a fingerprint sensor, an iris sensor, or an illuminance sensor) may be implemented as embedded in the display device 1260 (e.g., a display).

The processor 1220 may execute, for example, software (e.g., a program 1240) to control at least one other component (e.g., a hardware or software component) of the electronic device 1201 coupled with the processor 1220, and may perform various data processing or computation. According to one embodiment, as at least part of the data processing or computation, the processor 1220 may load a command or data received from another component (e.g., the sensor module 1276 or the communication module 1290) in volatile memory 1232, process the command or the data stored in the volatile memory 1232, and store resulting data in non-volatile memory 1234. According to an embodiment, the processor 1220 may include a main processor 1221 (e.g., a central processing unit (CPU) or an application processor (AP)), and an auxiliary processor 1223 (e.g., a graphics processing unit (GPU), an image signal processor (ISP), a sensor hub processor, or a communication processor (CP)) that is operable independently from, or in conjunction with, the main processor 1221. Additionally or alternatively, the auxiliary processor 1223 may be adapted to consume less power than the main processor 1221, or to be specific to a specified function. The auxiliary processor 1223 may be implemented as separate from, or as part of the main processor 1221.

The auxiliary processor 1223 may control at least some of functions or states related to at least one component (e.g., the display device 1260, the sensor module 1276, or the communication module 1290) among the components of the electronic device 1201, instead of the main processor 1221 while the main processor 1221 is in an inactive (e.g., sleep) state, or together with the main processor 1221 while the main processor 1221 is in an active state (e.g., executing an application). According to an embodiment, the auxiliary processor 1223 (e.g., an image signal processor or a communication processor) may be implemented as part of another component (e.g., the camera module 1280 or the communication module 1290) functionally related to the auxiliary processor 1223.

The memory 1230 may store various data used by at least one component (e.g., the processor 1220 or the sensor module 1276) of the electronic device 1201. The various data may include, for example, software (e.g., the program 1240) and input data or output data for a command related thereto. The memory 1230 may include the volatile memory 1232 or the non-volatile memory 1234.

The program 1240 may be stored in the memory 1230 as software, and may include, for example, an operating system (OS) 1242, middleware 1244, or an application 1246.

The input device 1250 may receive a command or data to be used by other component (e.g., the processor 1220) of the electronic device 1201, from the outside (e.g., a user) of the electronic device 1201. The input device 1250 may include, for example, a microphone, a mouse, a keyboard, or a digital pen (e.g., a stylus pen).

The sound output device 1255 may output sound signals to the outside of the electronic device 1201. The sound output device 1255 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 1260 may visually provide information to the outside (e.g., a user) of the electronic device 1201. The display device 1260 may include, for example, a display, a hologram device, or a projector and control circuitry to control a corresponding one of the display, hologram device, and projector. According to an embodiment, the display device 1260 may include touch circuitry adapted to detect a touch, or sensor circuitry (e.g., a pressure sensor) adapted to measure the intensity of force incurred by the touch.

The audio module 1270 may convert a sound into an electrical signal and vice versa. According to an embodiment, the audio module 1270 may obtain the sound via the input device 1250, or output the sound via the sound output device 1255 or a headphone of an external electronic device (e.g., an electronic device 1202) directly (e.g., wiredly) or wirelessly coupled with the electronic device 1201.

The sensor module 1276 may detect an operational state (e.g., power or temperature) of the electronic device 1201 or an environmental state (e.g., a state of a user) external to the electronic device 1201, and then generate an electrical signal or data value corresponding to the detected state. According to an embodiment, the sensor module 1276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1277 may support one or more specified protocols to be used for the electronic device 1201 to be coupled with the external electronic device (e.g., the electronic device 1202) directly (e.g., wiredly) or wirelessly. According to an embodiment, the interface 1277 may include, for example, a high definition multimedia interface (HDMI), a universal serial bus (USB) interface, a secure digital (SD) card interface, or an audio interface.

A connecting terminal 1278 may include a connector via which the electronic device 1201 may be physically connected with the external electronic device (e.g., the electronic device 1202). According to an embodiment, the connecting terminal 1278 may include, for example, a HDMI connector, a USB connector, a SD card connector, or an audio connector (e.g., a headphone connector).

The haptic module 1279 may convert an electrical signal into a mechanical stimulus (e.g., a vibration or a movement) or electrical stimulus which may be recognized by a user via his tactile sensation or kinesthetic sensation. According to an embodiment, the haptic module 1279 may include, for example, a motor, a piezoelectric element, or an electric stimulator.

The camera module 1280 may capture a still image or moving images. According to an embodiment, the camera module 1280 may include one or more lenses, image sensors, image signal processors, or flashes.

The power management module 1288 may manage power supplied to the electronic device 1201. According to one embodiment, the power management module 1288 may be implemented as at least part of, for example, a power management integrated circuit (PMIC).

The battery 1289 may supply power to at least one component of the electronic device 1201. According to an embodiment, the battery 1289 may include, for example, a primary cell which is not rechargeable, a secondary cell which is rechargeable, or a fuel cell.

The communication module 1290 may support establishing a direct (e.g., wired) communication channel or a wireless communication channel between the electronic device 1201 and the external electronic device (e.g., the electronic device 1202, the electronic device 1204, or the server 1208) and performing communication via the established communication channel. The communication module 1290 may include one or more communication processors that are operable independently from the processor 1220 (e.g., the application processor (AP)) and supports a direct (e.g., wired) communication or a wireless communication. According to an embodiment, the communication module 1290 may include a wireless communication module 1292 (e.g., a cellular communication module, a short-range wireless communication module, or a global navigation satellite system (GNSS) communication module) or a wired communication module 1294 (e.g., a local area network (LAN) communication module or a power line communication (PLC) module). A corresponding one of these communication modules may communicate with the external electronic device via the first network 1298 (e.g., a short-range communication network, such as Bluetooth™, wireless-fidelity (Wi-Fi) direct, or infrared data association (IrDA)) or the second network 1299 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1292 may identify and authenticate the electronic device 1201 in a communication network, such as the first network 1298 or the second network 1299, using subscriber information (e.g., international mobile subscriber identity (IMSI)) stored in the subscriber identification module 1296.

The antenna module 1297 may transmit or receive a signal or power to or from the outside (e.g., the external electronic device) of the electronic device 1201. According to an embodiment, the antenna module 1297 may include an antenna including a radiating element composed of a conductive material or a conductive pattern formed in or on a substrate (e.g., PCB). According to an embodiment, the antenna module 1297 may include a plurality of antennas. In such a case, at least one antenna appropriate for a communication scheme used in the communication network, such as the first network 1298 or the second network 1299, may be selected, for example, by the communication module 1290 (e.g., the wireless communication module 1292) from the plurality of antennas. The signal or the power may then be transmitted or received between the communication module 1290 and the external electronic device via the selected at least one antenna. According to an embodiment, another component (e.g., a radio frequency integrated circuit (RFIC)) other than the radiating element may be additionally formed as part of the antenna module 1297.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1201 and the external electronic device 1204 via the server 1208 coupled with the second network 1299. Each of the electronic devices 1202 and 1204 may be a device of a same type as, or a different type, from the electronic device 1201. According to an embodiment, all or some of operations to be executed at the electronic device 1201 may be executed at one or more of the external electronic devices 1202, 1204, or 1208. For example, if the electronic device 1201 should perform a function or a service automatically, or in response to a request from a user or another device, the electronic device 1201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1201. The electronic device 1201 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1240) including one or more instructions that are stored in a storage medium (e.g., internal memory 1236 or external memory 1238) that is readable by a machine (e.g., the electronic device 1201). For example, a processor (e.g., the processor 1220) of the machine (e.g., the electronic device 1201) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device, comprising:
a display;
a memory; and
a processor configured to:
set a plurality of products into a plurality of product groups based on respective specific factor values of the plurality of products;
set the plurality of product groups into a plurality of segments based on comparison between the plurality of product groups;
identify per-segment information for the plurality of segments;
generate forecast data by processing prior time-series data based on the per-segment information; and
control the display to display at least part of the forecast data.

2. The electronic device of claim 1, wherein the specific factor values are used to classify the plurality of products.

3. The electronic device of claim 1, wherein the plurality of products are placed into the plurality of segments based on time.

4. The electronic device of claim 1, wherein the specific factors are set depending on product types.

5. The electronic device of claim 1, wherein the processor is further configured to reset the plurality of product groups and the plurality of segments based on an update on the plurality of products.

6. The electronic device of claim 1, wherein the per-segment information comprises at least one of a correction factor, a weight, and a seasonal factor set for each of the plurality of segments.

7. The electronic device of claim 1, wherein the per-segment information is set based on the prior time-series data.

8. The electronic device of claim 1, wherein the prior time-series data comprises data during a segmented period, and the forecast data comprises data during a summated period corresponding to a plurality of segmented periods.

9. The electronic device of claim 1, wherein the prior time-series data comprises time-series data during a first period before a specific time, and the forecast data comprises time-series data during a second period after the specific time, and
wherein the second period is set to be longer than the first period.

10. The electronic device of claim 1, wherein the prior time-series data comprises at least one of per-product data for the plurality of products, per-product group data for the plurality of product groups, and per-segment data for a plurality of preset segments.

11. The electronic device of claim 1, wherein the processor is further configured to set the plurality of product groups into the plurality of segments based on a designated clustering rule.

12. The electronic device of claim 1, wherein the processor is further configured to, upon setting the plurality of product groups into the plurality of segments, sequentially classify non-dominated sets from the plurality of product groups based on comparison between the plurality of product groups and set the non-dominated sets into the plurality of segments.

13. A method of data forecast analysis, the method comprising:
setting a plurality of products into a plurality of product groups based on respective specific factor values of the plurality of products;
setting the plurality of product groups into a plurality of segments based on comparison between the plurality of product groups;
identifying per-segment information for the plurality of segments;
generating forecast data by processing prior time-series data based on the per-segment information; and
displaying at least part of the forecast data on a display.

14. The method of claim 13, wherein the specific factor values are used to classify the plurality of products.

15. The method of claim 13, wherein the plurality of products are placed into the plurality of segments based on time.

16. The method of claim 13, wherein the specific factors are set depending on product types.

17. The method of claim 13, further comprising resetting the plurality of product groups and the plurality of segments based on an update on the plurality of products.

18. The method of claim 13, wherein the per-segment information comprises at least one of a correction factor, a weight, and a seasonal factor set for each of the plurality of segments.

19. The method of claim 13, wherein the per-segment information is set based on the prior time-series data.

20. The method of claim 13, wherein the prior time-series data comprises data during a segmented period, and the forecast data comprises data during a summated period corresponding to a plurality of segmented periods.
